(19) United States
(12) Patent Application Publication
(10) Pub. No.: US 2024/0130297 A1
(43) Pub. Date: Apr. 25, 2024

(54) Garden Cart Assembly

(71) Applicant: Andrew Camacho, JR., Long Beach, NY (US)

(72) Inventor: Andrew Camacho, JR., Long Beach, NY (US)

(21) Appl. No.: 17/973,312

(22) Filed: Oct. 24, 2022

(51) Int. Cl. A01G 9/02; A01G 7/04

(52) U.S. Cl. CPC A01G 9/023; A01G 7/045

(57) ABSTRACT

A garden cart assembly includes a plurality of legs that is oriented such that each of the legs defines a respective one of four corners of a rectangle. A plurality of rollers is each rotatably attached to a respective one of the legs thereby facilitating the plurality of legs to roll along a support surface. A roof is attached to the plurality of legs and the roof has a pair of pitched sections that defines a peak. A plurality of shelves is each attached to the plurality of legs thereby facilitating each of the shelves to support a potted plant. A plurality of light emitters is each attached to a respective one of the roof and the shelves. Each of the light emitters is oriented to emit light downwardly from the respective roof or shelf to direct light onto the potted plants.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to cart devices and more particularly pertains to a new cart device for growing potted plants indoors. The device includes a cart with a roof and a plurality of shelves upon which large potted plants can be placed. A plurality of light emitters is each attached to a respective one of the roof and the shelves. Each of the light emitters directs light downwardly onto a respective one of the shelves for enhancing the growth of the potted plants. Additionally, the cart includes a plurality of rollers for rolling the cart along a support surface.

### (2) Description of Related Art Including Information Disclosed Under 37 CFR 1.97 and 1.98

The prior art relates to cart devices including wheeled cart that has a plurality of stacked shelves for supporting potted plants. The device includes a wheeled cart that has a plurality of planting boxes for holding plants. The prior art discloses a variety of plant stands that each at least includes a plurality of stacked shelves. The prior art discloses a plant stand that includes a panel that is pivotally mounted to a pair of uprights.

### Brief Summary of the Invention

An embodiment of the disclosure meets the needs presented above by generally comprising a plurality of legs that is oriented such that each of the legs defines a respective one of four corners of a rectangle. A plurality of rollers is each rotatably attached to a respective one of the legs thereby facilitating the plurality of legs to roll along a support surface. A roof is attached to the plurality of legs and the roof has a pair of pitched sections that defines a peak. A plurality of shelves is each attached to the plurality of legs thereby facilitating each of the shelves to support a potted plant. A plurality of light emitters is each attached to a respective one of the roof and the shelves. Each of the light emitters is oriented to emit light downwardly from the respective roof or shelf to direct light onto the potted plants.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a garden cart assembly according to an embodiment of the disclosure.

FIG. 2 is a right side perspective in-use view of an embodiment of the disclosure.

FIG. 3 is a top view of an embodiment of the disclosure.

FIG. 4 is a front view of an embodiment of the disclosure.

### DETAILED DESCRIPTION OF THE INVENTION

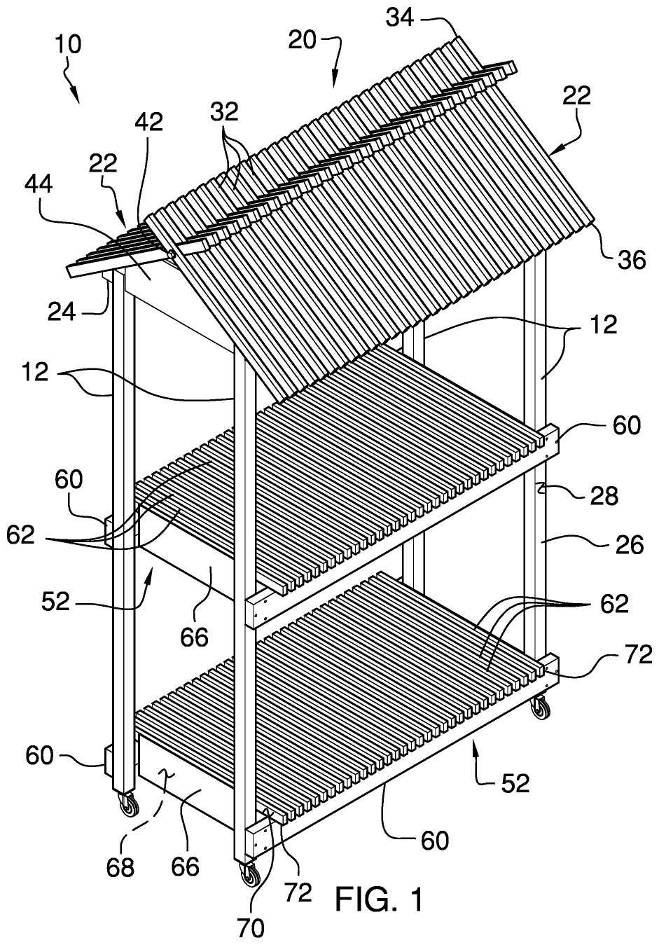

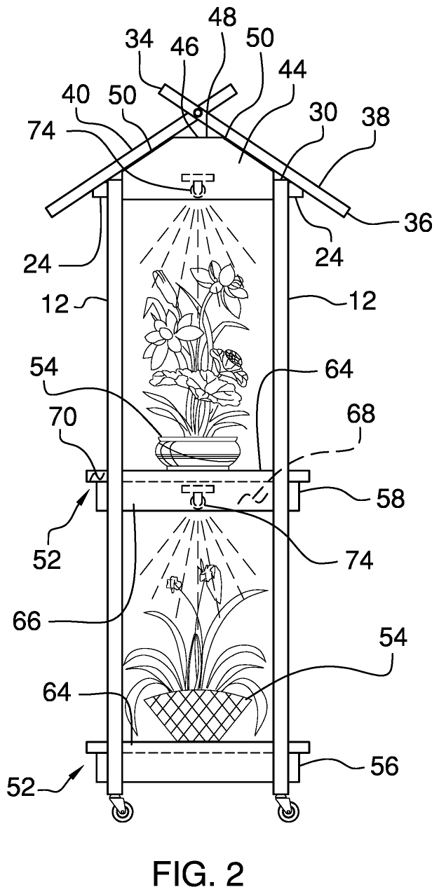

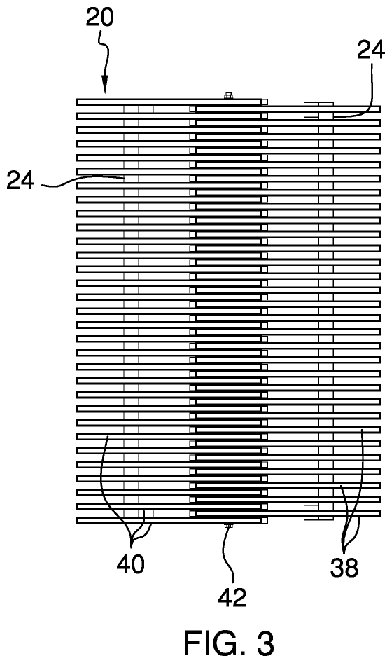

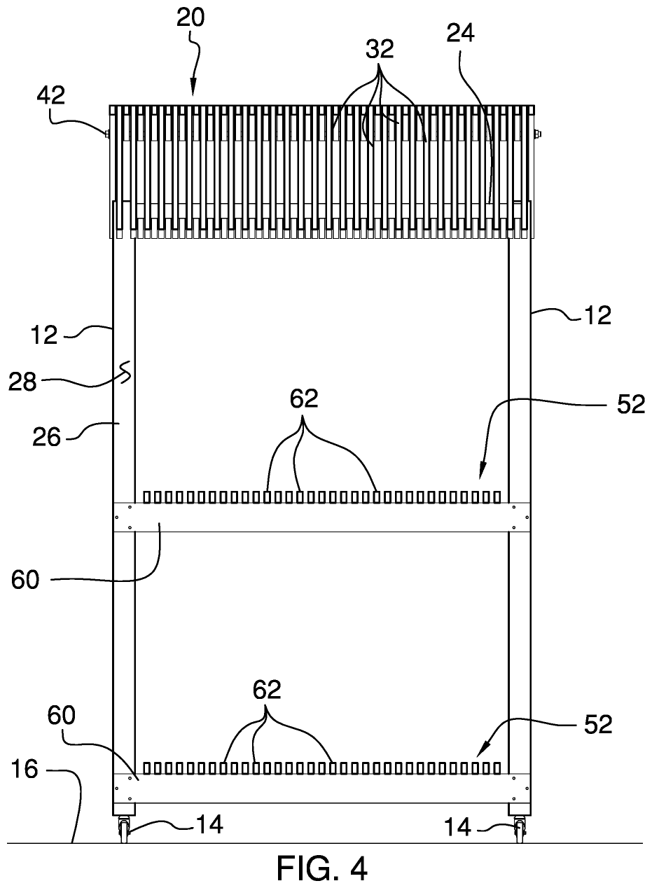

With reference now to the drawings, and in particular to FIGS. 1 through 4 thereof, a new cart device embodying the principles and concepts of an embodiment of the disclosure and generally designated by the reference numeral 10 will be described.

As best illustrated in FIGS. 1 through 4, the garden cart assembly 10 generally comprises a plurality of legs 12 oriented such that each of the legs 12 defines a respective one of four corners of a rectangle. The plurality of legs 12 may have a height of at least 150.0 cm. A plurality of rollers 14 is each rotatably attached to a respective one of the legs 12 thereby facilitating the plurality of legs 12 to roll along a support surface 16. Additionally, each of the rollers 14 is positioned on a bottom end 18 of the respective leg 12 and each of the rollers 14 may comprise locking casters or other similar type of wheel.

A roof 20 is attached to the plurality of legs 12 and the roof 20 has a pair of pitched sections 22 such that the pitched sections 22 of the roof 20 define a peak. The roof 20 comprises a pair of roof supports 24 that is each coupled to and extends between a respective pair of the legs 12. Each of the roof supports 24 is positioned on a long side of the rectangle defined by the legs 12. Each of the roof supports 24 is positioned on an outwardly facing side 26 of an outer surface 28 of the respective pair of legs 12 and each of the roof supports 24 is aligned with a top end 30 of the respective leg 12.

The roof 20 includes a plurality of roof slats 32 that each has a first end 34 and a second end 36. The roof slats 32 are interlaced with each other at a point that is spaced from the first end 34. Furthermore, the roof slats 32 are arranged into a group of first roof slats 38 that is staggered with respect to a group of second roof slats 40 such that each of the first roof slats 38 and the second roof slats 40 defines a respective one of the pitched sections 22 of the roof 20. Each of the first roof slats 38 lies on a respective one of the roof supports 24 having the first roof slats 38 angling upwardly from the respective roof support 24. Additionally, each of the second roof slats 40 lies on a respective one of the roof supports 24 has the second roof slats 40 angling upwardly from the respective roof support 24.

The roof 20 includes a rod 42 extending through each of the roof slats 32 at the point that is spaced from the first end 34 of the roof slats 32 such that each of the roof slats 32 is pivotally retained on the rod 42. The rod 42 is oriented to extend along an axis oriented parallel with each of the roof supports 24 and each of the roof slats 32 angles upwardly between the roof supports 24 and the rod 42. The roof 20 includes a pair of gables 44 and each of the gables 44 is coupled between a respective pair of the legs 12 and each of the gables 44 is aligned with a top end 30 of the respective leg 12. Each of the gables 44 extends along a respective short side of the rectangle defined by the legs 12. Each of the gables 44 has an upper edge 46 and the upper edge 46 has an upper section 48 extending between a pair of angled sections 50 and each of the angled sections 50 angles downwardly from the upper section 48. A respective one of each of the first roof slats 38 and a respective one of the second roof slats 40 lies on a respective one of the angled sections 50 of the upper edge 46 of a respective one of the gables 44.

A plurality of shelves 52 is each attached to the plurality of legs 12 thereby facilitating each of the shelves 52 to support a potted plant 54. The shelves 52 are spaced apart from each other and are distributed along the legs 12 thereby facilitating the shelves 52 to accommodate a potted plant 54 with a height of more than 40.0 cm. The plurality of shelves 52 includes a bottom shelf 56 that is positioned adjacent to the bottom end 18 of the legs 12 and a middle shelf 58 is positioned between the bottom shelf 56 and the roof 20. Each of the middle shelf 58 and the bottom shelf 56 comprises a pair of shelf supports 60 that is each coupled to and extends between a respective pair of the legs 12. Each of the shelf supports 60 is positioned on the long side of the rectangle defined by the legs 12 and each of the shelf supports 60 is positioned on the outwardly facing side 26 of the outer surface 28 of the respective pair of legs 12. Additionally, each of the shelf supports 60 is perpendicularly oriented with the legs 12.

Each of the shelves 52 includes a plurality of shelf slats 62 that is each positioned on top of the pair of shelf supports 60 such that each of the shelf slats 62 extends beyond each of the shelf supports 60. The shelf slats 62 are spaced apart from each other and are distributed along the pair of shelf supports 60 such that the plurality of shelf slats 62 defines a horizontal support surface 64 for the potted plants 54. Each of the shelves 52 includes a pair of end panels 66 that each has a first surface 68 which is attached to an exterior surface 70 of a respective one of an outermost pair of the shelf slats 72. Each of the end panels 66 extends along a substantial length of the respective outermost shelf slat 72 and each of the end panels 66 extends downwardly beyond the respective outermost shelf slat 72.

A plurality of light emitters 74 is each attached to a respective one of the roof 20 and the shelves 52. Each of the light emitters 74 is oriented to emit light downwardly from the respective roof 20 or shelf to direct light onto the potted plants 54 and each of the light emitters 74 emits light of a frequency that is beneficial to plant growth. The light emitter 74 associated with the roof 20 extends between the pair of gables 44 thereby facilitating the light emitter 74 associated with the roof 20 to emit light downwardly onto the middle shelf 58. The light emitter 74 associated with the shelves 52 extends between the pair of end panels 66 of the middle shelf 58 thereby facilitating the light emitter 74 associated with the shelves 52 to emit light downwardly onto the bottom shelf 56. Each of the light emitters 74 may comprise a light emitting diode or other type of electronic light emitter that is commonly employed for growing plants.

In use, the potted plants 54 are positioned on a respective one of the shelves 52 for growing indoors. The height between the shelves 52 and the roof 20 facilitates large potted plants 54 to be grown on the shelves 52. The light emitters 74 are turned on at desired times in order to enhance growth of the potted plants 54. In this way the potted plants 54 can be grown indoors and the potted plants 54 can be easily transported together by rolling the rollers 14 along the support surface 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A garden cart assembly for supporting a plurality of large potted plants in an indoor location, said assembly comprising:
a plurality of legs being oriented such that each of said legs defines a respective one of four corners of a rectangle;
a plurality of rollers, each of said rollers being rotatably attached to a respective one of said legs thereby facilitating said plurality of legs to roll along a support surface;
a roof being attached to said plurality of legs, said roof having a pair of pitched sections such that said pitched sections of said roof defines a peak;
a plurality of shelves, each of said shelves being attached to said plurality of legs thereby facilitating each of said shelves to support a potted plant, said shelves being spaced apart from each other and being distributed along said legs; and
a plurality of light emitters, each of said light emitters being attached to a respective one of said roof and said shelves, each of said light emitters being oriented to emit light downwardly from said respective roof or shelf wherein each of said light emitters is configured to direct light onto the potted plants, each of said light emitters emitting light of a frequency being beneficial to plant growth.

2. The assembly according to claim 1, wherein said roof comprises:
a pair of roof supports, each of said roof supports being coupled to and extending between a respective pair of said legs, each of said roof supports being positioned on a long side of said rectangle defined by said legs, each of said roof supports being positioned on an outwardly facing side of an outer surface of said respective pair of legs, each of said roof supports being aligned with a top end of said respective leg;
a plurality of roof slats, each of said roof slats having a first end and a second end, said plurality of roof slats being interlaced with each other at a point being spaced from said first end, said plurality of roof slats being arranged into a group of first roof slats being staggered with respect to a group of second roof slats such that each of said first roof slats and said second roof slats defines a respective one of said pitched sections of said roof; and
each of said first roof slats lying on a respective one of said roof supports having said first roof slats angling upwardly from said respective roof support, each of said second roof slats lying on a respective one of said roof supports having said second roof slats angling upwardly from said respective roof support.

4. The assembly according to claim 3, wherein said roof comprises a rod extending through each of said roof slats at said point being spaced from said first end of said roof slats such that each of said roof slats is pivotally retained on said rod, said rod being oriented to extend along an axis being oriented parallel with each of said roof supports, each of said roof slats angling upwardly between said roof supports and said rod.

5. The assembly according to claim 3, wherein said roof comprises a pair of gables, each of said gables being coupled between a respective pair of said legs, each of said gables being aligned with a top end of said respective leg, each of said gables extending along a respective short side of said rectangle defined by said legs, each of said gables having an upper edge, said upper edge having an upper section extending between a pair of angled sections, each of said angled sections angling downwardly from said upper section, a respective one of each of said first roof slats and a respective one of said second roof slats lying on a respective one of said angled sections of said upper edge of a respective one of said gables.

6. The assembly according to claim 1, wherein said plurality of shelves includes a bottom shelf being positioned adjacent to said bottom end of said legs and a middle shelf being positioned between said bottom shelf and said roof, each of said middle shelf and said bottom shelf comprising:
a pair of shelf supports, each of said shelf supports being coupled to and extending between a respective pair of said legs, each of said shelf supports being positioned on said long side of said rectangle defined by said legs, each of said shelf supports being positioned on said outwardly facing side of said outer surface of said respective pair of legs, each of said shelf supports being perpendicularly oriented with said legs;
a plurality of shelf slats, each of said shelf slats being positioned on top of said pair of shelf supports such that each of said shelf slats extends beyond each of said shelf supports, said shelf slats being spaced apart from each other and being distributed along said pair of shelf supports such that said plurality of shelf slats defines a horizontal support surface for the potted plants; and
a pair of end panels, each of said end panels having a first surface being attached to an exterior surface of a respective one of an outermost pair of said shelf slats, each of said end panels extending along a substantial length of said respective outermost shelf slat, each of said end panels extending downwardly beyond said respective outermost shelf slat.

7. The assembly according to claim 5, wherein said light emitter associated with said roof extends between said pair of gables thereby facilitating said light emitter associated with said roof to emit light downwardly onto a middle shelf.

8. The assembly according to claim 6, wherein said light emitter associated with said shelves extending between said pair of end panels of a middle shelf thereby facilitating said light emitter associated with said shelves to emit light downwardly onto a bottom shelf.

9. A garden cart assembly for supporting a plurality of large potted plants in an indoor location, said assembly comprising:
a plurality of legs being oriented such that each of said legs defines a respective one of four corners of a rectangle;
a plurality of rollers, each of said rollers being rotatably attached to a respective one of said legs thereby facilitating said plurality of legs to roll along a support surface, each of said rollers being positioned on a bottom end of said respective leg;
a roof being attached to said plurality of legs, said roof having a pair of pitched sections such that said pitched sections of said roof defines a peak, said roof comprising:
a pair of roof supports, each of said roof supports being coupled to and extending between a respective pair of said legs, each of said roof supports being positioned on a long side of said rectangle defined by said legs, each of said roof supports being positioned on an outwardly facing side of an outer surface of said respective pair of legs, each of said roof supports being aligned with a top end of said respective leg;
a plurality of roof slats, each of said roof slats having a first end and a second end, said plurality of roof slats being interlaced with each other at a point being spaced from said first end, said plurality of roof slats being arranged into a group of first roof slats being staggered with respect to a group of second roof slats such that each of said first roof slats and said second roof slats defines a respective one of said pitched sections of said roof, each of said first roof slats lying on a respective one of said roof supports having said first roof slats angling upwardly from said respective roof support, each of said second roof slats lying on a respective one of said roof supports having said second roof slats angling upwardly from said respective roof support;
a rod extending through each of said roof slats at said point being spaced from said first end of said roof slats such that each of said roof slats is pivotally retained on said rod, said rod being oriented to extend along an axis being oriented parallel with each of said roof supports, each of said roof slats angling upwardly between said roof supports and said rod; and
a pair of gables, each of said gables being coupled between a respective pair of said legs, each of said gables being aligned with a top end of said respective leg, each of said gables extending along a respective short side of said rectangle defined by said legs, each of said gables having an upper edge, said upper edge having an upper section extending between a pair of angled sections, each of said angled sections angling downwardly from said upper section, a respective one of each of said first roof slats and a respective one of said second roof slats lying on a respective one of said angled sections of said upper edge of a respective one of said gables;
a plurality of shelves, each of said shelves being attached to said plurality of legs thereby facilitating each of said shelves to support a potted plant, said shelves being spaced apart from each other and being distributed along said legs, said plurality of shelves including a bottom shelf being positioned adjacent to said bottom end of said legs and a middle shelf being positioned between said bottom shelf and said roof, each of said middle shelf and said bottom shelf comprising:
a pair of shelf supports, each of said shelf supports being coupled to and extending between a respective pair of said legs, each of said shelf supports being positioned on said long side of said rectangle defined by said legs, each of said shelf supports being positioned on said outwardly facing side of said outer surface of said respective pair of legs, each of said shelf supports being perpendicularly oriented with said legs;
a plurality of shelf slats, each of said shelf slats being positioned on top of said pair of shelf supports such that each of said shelf slats extends beyond each of said shelf supports, said shelf slats being spaced apart from each other and being distributed along said pair of shelf supports such that said plurality of shelf slats defines a horizontal support surface for the potted plants; and
a pair of end panels, each of said end panels having a first surface being attached to an exterior surface of a respective one of an outermost pair of said shelf slats, each of said end panels extending along a substantial length of said respective outermost shelf slat, each of said end panels extending downwardly beyond said respective outermost shelf slat; and
a plurality of light emitters, each of said light emitters being attached to a respective one of said roof and said shelves, each of said light emitters being oriented to emit light downwardly from said respective roof or shelf wherein each of said light emitters is configured to direct light onto the potted plants, each of said light emitters emitting light of a frequency being beneficial to plant growth, said light emitter associated with said roof extending between said pair of gables thereby facilitating said light emitter associated with said roof to emit light downwardly onto said middle shelf, said light emitter associated with said shelves extending between said pair of end panels of said middle shelf thereby facilitating said light emitter associated with said shelves to emit light downwardly onto said bottom shelf.
